(19) United States
(12) Patent Application Publication
(10) Pub. No.: US 2026/0149952 A1
(43) Pub. Date: May 28, 2026

(54) MODIFICATION OF COMMUNICATION CONNECTION PROCESS TO COUNTERACT/DIFFUSE DETECTED EMOTIONAL STATE OF DEVICE USER

(71) Applicant: MOTOROLA MOBILITY LLC, WILMINGTON, DE (US)

(72) Inventors: AMIT KUMAR AGRAWAL, BANGALORE (IN); VIJAYPRAKASH IDLUR, BANGALORE (IN); PANDURANGA REDDY PAILLA, NALGONDA (IN)

(21) Appl. No.: 18/956,660

(22) Filed: Nov. 22, 2024

(51) Int. Cl. H04W 4/16

(52) U.S. Cl. CPC H04W 4/16

(57) ABSTRACT

An electronic device delays communication connection and/or presents soothing output during communication initiation in response to detecting user's first emotional state. The electronic device has a memory including a communication management module, a communications subsystem that links the electronic device to a communication network, and a processor. The processor is configured to cause the electronic device to: monitor an emotional state of a user of the electronic device; and in response to detecting that the user is in a first emotional state while communication event with a second electronic device is being connected present a soothing output via at least one output device prior to completing a connection of the communication event. The processor is further configured to cause the electronic device to delay the connection of the communication event to enable the soothing output to be presented to the user for at least a pre-established cooling off period.

### BACKGROUND

### 1. Technical Field

The present disclosure relates generally to electronic devices that support person-to-person(s) communication, and more particularly to electronic devices that support real-time person-to-person communication including voice/video calls.

### 2. Description of the Related Art

Electronic communication devices such as smartphones enable users to receive incoming communication requests and initiate video or voice communication sessions with one or more second electronic devices. Users are able to initiate a communication session quickly with the electronic communication device, which captures and transmits text, voice, or gestures efficiently and promptly. The conversation between users of connected electronic communication devices can have the rapidity of an in-person conversation and include similar emotional components expressed by the respective user.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates a further block diagram of the electronic device configured to present soothing output in response to detecting a first emotional state of a user, according to one or more embodiments;

FIG. 3 illustrates a software platform diagram of an artificial intelligence (AI) operating system (OS) of the electronic device, according to one or more embodiments;

FIG. 4 illustrates a data and processing flow diagram for a communication operation management (COM) module providing functionality for receiving and processing context aware, personal, collaborative, and ubiquitous data sources for determining whether the user is in a first emotional state, according to one or more embodiments;

FIG. 5 illustrates a display and an audio output device of the electronic device presenting soothing outputs in response to identifying the first emotional state of the user during an incoming call request, according to one or more embodiments;

FIG. 6 illustrates a display and an audio output device of the electronic device presenting soothing outputs in response to identifying the first emotional state of the user during an audio or video call initiation, according to one or more embodiments;

FIG. 7 illustrates a display and an audio output device of the electronic device presenting soothing outputs in response to identifying the first emotional state of the user during a chat conversation, according to one or more embodiments;

FIGS. 8A-8B (collectively “FIG. 8”) are a flow diagram presenting a computer-implement method for presenting soothing output(s) in response to detecting a first emotional state of the communication device user during a communication connection process, according to one or more embodiments; and

FIG. 9 is a flow diagram presenting a computer-implement method that augments the method of FIG. 8 for identifying the first emotional state based on a physiological input and a motion input, according to one or more embodiments.

### DETAILED DESCRIPTION

According to aspects of the present disclosure, an electronic device, a method and a computer program provide various techniques for modification of a communication connection process to counteract/diffuse detected emotional state of a user of the electronic device. By intervening before an outgoing communication is sent, the techniques may prevent sending inappropriate or ill-advised content. In response to detecting or predicting that the user of the electronic device is in a “first” emotional state that is associated with making imprudent, impulsive decisions, the techniques include presenting soothing output to calm the user, mitigating the risk of sending regrettable content. In one or more embodiments, the presentation of the soothing output may prompt the user to voluntarily delay taking any user action to send the regrettable content until sufficiently in control of the user's emotions. Alternatively, the techniques may include delaying the communication connection while presenting soothing output in response to detecting user's first emotional state. In some embodiments, the disclosure provides techniques for delaying call connection (initiation or reception) by presenting positive mood enhancing output to a user during a pre-call connection process, in response to detecting an elevated (non-calm) emotional state of the device user.

Examples of the first emotional state includes the user expressing deep despair, overwhelming anxiety, uncontrolled anger, grief, trauma, stress, emotional burnout, and seasonable effective disorders. For purposes of the disclosure, “first emotional state” is described as a mental or physiological state of the device user that is determined or evaluated to produce, with some degree of certainty, an imprudent and impulsive frame of mind having a propensity to make hurtful, obscene, confidential, or hyperbolic statements. An AI engine may determine or predict that the user is in the first emotional state based on a plurality of factors such as aural, visual, contextual, and physiological inputs. As an example of a contextual input, the person with whom the communication session is with may have a history of provoking the user.

During normal call initiation at a communication device, the electronic device presents the incoming call or connects an outgoing call for the user to accept or initiate a communication session with another call participant at a corresponding one or more second electronic devices. The call connection is immediately completed even though, in certain circumstances, the user of the electronic device may not be in a suitable emotional state to engage in the communication. The first emotional state corresponds to when a device user is angry or is experiencing other similar volatile emotional states. While in the first emotional state, the user may communicate hurtful, disrespectful, or confidential statement that can result in detrimental repercussions, such as damaging a personal or professional relationship. Certain statements made during such occurrences where the user temporarily lacks emotional control may even be legally actionable.

The embodiments disclosed herein address and overcome the aforementioned issues/problems/limitations by automatically mitigating a first emotion state of a user. In an example, an emotional well-being module of the electronic device may be enabled by various device settings for communication modes such as voice or video calls, text chats, and other forms of communications, either initiated by or received by the electronic device. Detection of a first emotion state may be determined at least in part based on device sensors such as cameras, microphones, user-worn devices such as fitness bands/rings, smartwatches, etc. Artificial intelligence (AI) engines/models may be trained or may learn from user behavior to correlate certain physiological parameters and people/event contexts to predict or detect the first emotional state. In an example, the voice of the user may change in pitch, volume, speed, word choice, etc., depending on emotional state. When the user is not in the first emotional state, the electronic device manages communication operations (e.g., call receiving and initiating) in a normal, call flow, which does not include delays in connecting the communication. However, when the user is in the first emotional state, the electronic device delays connection of a call session, and generates one or more outputs that are predetermined to prevent/mitigate the user engaging in an inappropriate communication. The delay may fake a normal, extenuated, communication setup. Additionally, or alternatively, in some embodiments, the electronic device may provide an explanation for the delay. It is expected that in some embodiments, the delay, by itself, may allow the user to collect themselves to communicate appropriately.

In some embodiments, the electronic device may present to the user a soothing visual and/or audio output to improve the mood of the user. In an example, the electronic device may overlay a pre-selected soothing tune onto the ongoing call, regardless of and/or in place of the original tune. The soothing caller tune may be a known audio tune that reduces stress and promotes relaxation, such as a calming melody, nature sounds, or binaural beats. The choice of soothing output may be based on crowd sourced data about generally soothing outputs. Alternatively, or in addition, the soothing output may be based on AI learned content that has been shown to be effective for the particular user.

According to one or more embodiments, an electronic device includes at least one input device and at least one output device. The electronic device has a memory including a communication operation management module. The electronic device includes a communications subsystem that links the electronic device to a communication network. The electronic device includes a processor communicatively coupled to the at least one input device, the at least one output device, the memory, and the communications subsystem. The processor is configured to cause the electronic device to identify when a communication event is being connected, via the communications subsystem, with at least a second electronic device. In response to detecting that the user of the electronic device is in a first emotional state prior to connecting the communication event, the processor is configured to cause the electronic device to present a soothing output via the at least one output device prior to completing a connection of the communication event. According to one aspect of the disclosure, the user is expected to respond to the soothing output by voluntarily delaying any user action that would result in an objectionable outgoing communication. Alternatively, the processor is configured to cause the electronic device to delay the connection of the communication event to enable the soothing output to be presented to the user for at least a pre-established cooling off period.

According to one or more embodiments, a method is provided for presenting soothing output during a communication connection in response to detecting user's first emotional state. In response to detecting that the user of the electronic device is in a first emotional state prior to connecting a communication event between an electronic device and at least a second electronic device, the method includes presenting a soothing output via at least one output device prior to completing a connection of the communication event. In one or more embodiments, the method may further include delaying the connection of the communication event to enable the soothing output to be presented to the user for at least a pre-established cooling off period rather than relying on the user to voluntarily delay any user action that would result in an objectionable outgoing communication.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

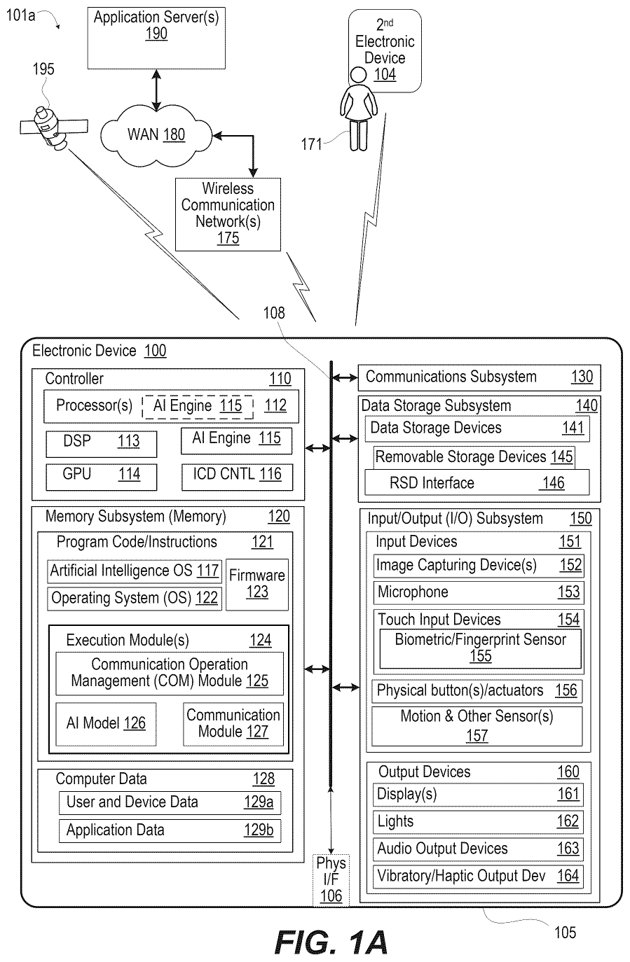

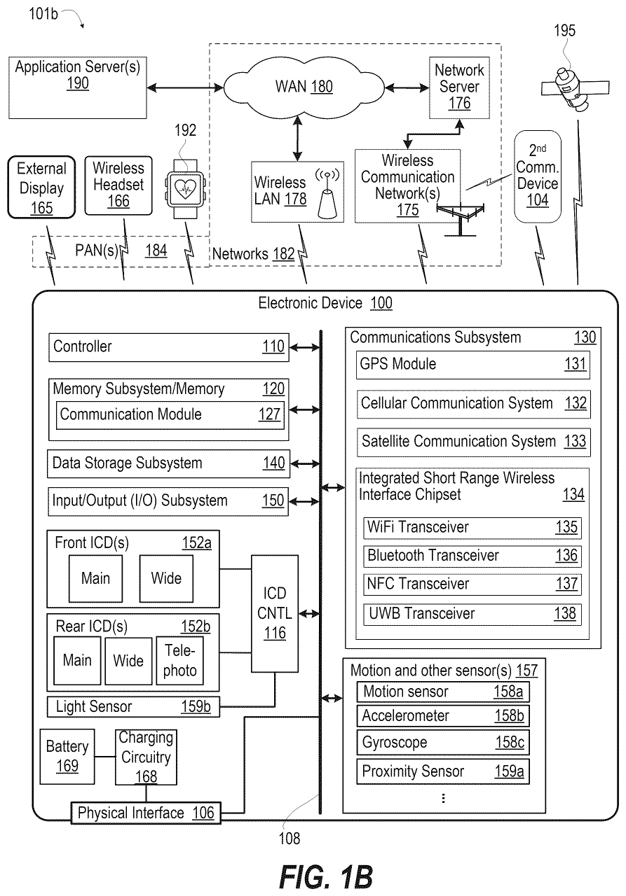

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

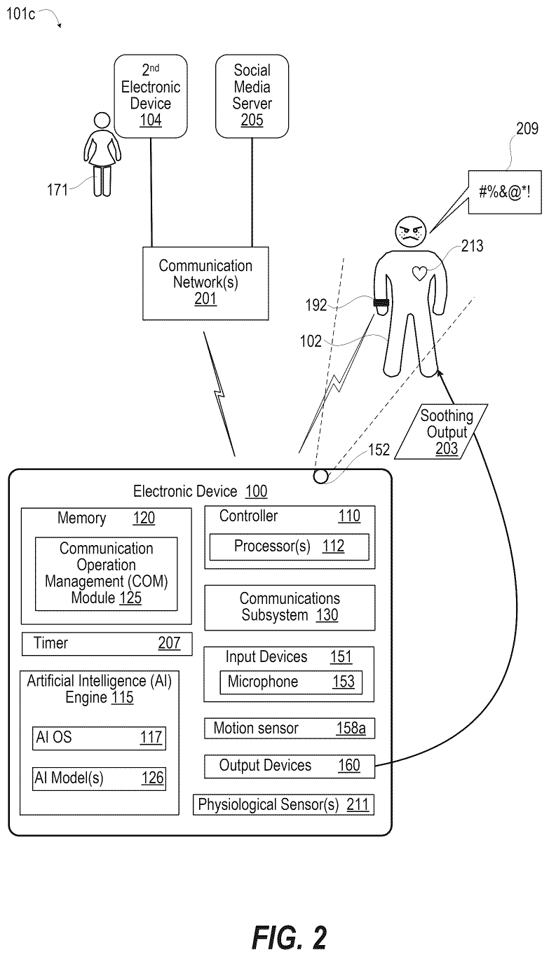

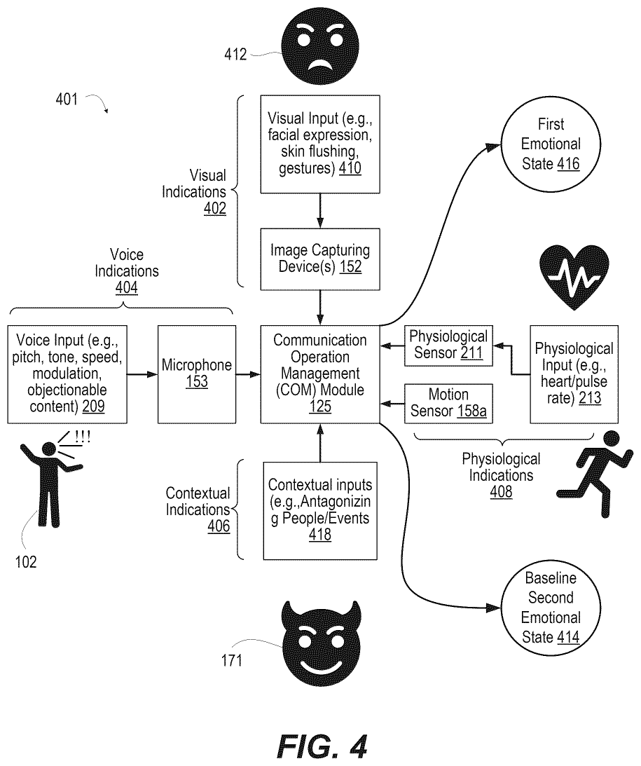

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 detects that user 102 of electronic device 100 is in an emotional state prior to connecting a communication event with second electronic device(s) 104. In response, electronic device 100 presents a soothing output prior to completing a connection of the communication event. Electronic device 100 delays the connection of the communication event to enable the soothing output to be presented user 102 for at least a pre-established cooling off period. Examples of soothing outputs are described below with regard to FIGS. 2 and 4.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that is described below with regard to FIG. 2.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, communication operation management (COM) module 125, which provides the features and operating functionality of the disclosed embodiments when the corresponding program instructions of COM module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within COM module 125 and is trained to support the AI features of COM module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, COM module 125 can include program instructions that cause or configure processor 112 to cause electronic device 100 to delay call initiation and presenting soothing output during call initiation in response to detecting user's first emotional state. Other features provided by COM module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of COM module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of COM module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

FIG. 2 illustrates a further communication block of electronic device 100 that delays call initiation via communication network 201 of communication environment 101c and that presents soothing output 203 during call initiation in response to detecting a first emotional state of user 102. Communication environment 101c may include portions of communication environment 101a (FIG. 1A) and communication environment 101b (FIG. 1B). Communication initiation may be for a communication session between electronic device 100 and one or more second electronic devices 104 that are user devices for respective second users 171. Communication initiation may be for a communication session between electronic device 100 and with intermediary network system such as social media server 205 that is accessible to one or more second electronic devices 104 that are user devices.

With reference to FIGS. 1A-1B , according to aspects of the present disclosure, electronic device 100 includes at least one input device 151 and at least one output device 160. Electronic device 100 has memory 120 including communication operation management (COM) module 125 that may configure electronic device 100 to handle an incoming communication initiation request for a two-way communication session. Alternatively, or in addition, COM module 125 may configure electronic device 100 to handle outgoing communication initiation for one-way communication (e.g., email, text, or social post). Alternatively, or in addition, COM module 125 may configure electronic device 100 to handle outgoing communication initiation for two-way communication (e.g., application chat session, audio session, or video session). The two-way communication session may be referred to as a “call” such that COM module 125 configures electronic device 100 to manage call operations. Electronic device 100 includes communications subsystem 130 that links electronic device 100 to communication network 201 for the one-way or two-way communication session. Processor 112 of electronic device 100 is communicatively coupled to memory 120, communications subsystem 130, at least one input device 151, and at least one output device 160. In response to detecting that user 102 of electronic device 100 is in a first emotional state prior to connecting a communication event (e.g., two-way audio, video or chat communication session or a one-way outgoing audio, video, or message), via communications subsystem 130, with at least one second electronic device 104, processor 112 is configured to cause electronic device 100 to present soothing output 203 via at least one output device 160 prior to completing a connection of the communication event. Processor 112 is configured to cause electronic device 100 to delay the connection of the communication event to enable soothing output 203 to be presented to user 102 for at least a pre-established cooling off period.

In one or more embodiments, processor 112 is configured to cause electronic device 100 to perform background monitoring for inputs received by electronic device 100 correlated to an emotional state of user 102. Processor 112 is configured to cause electronic device 100 to determine from the inputs whether the emotional state of user 102 is the first emotional state. Processor 112 is configured to cause electronic device 100 to set a communication mode of electronic device 100 to an intervention communication mode that requires soothing user 102 is to be completed prior to completion of a subsequent connection while the emotional state of user 102 is determined to be the first emotional state. Processor 112 is configured to cause electronic device 100 to operate electronic device 100 in a normal communication mode that does not present soothing output 203, in response to one of (i) determining the emotional state of user 102 is not a first emotional state or (ii) passage of the pre-established cooling off period to diffuse the first emotional state.

In one or more particular embodiments, in response to determining from the inputs that the emotional state of user 102 is the first emotional state, processor 112 is configured to cause electronic device 100 to activate timer 207 configured to measure the pre-established cooling off period. Processor 112 is configured to cause electronic device 100 to perform subsequent background monitoring for subsequent inputs received by electronic device 100 correlated to the emotional state of user 102 during the pre-established cooling off period. Processor 112 is configured to cause electronic device 100 to re-activate timer 207 in response to a subsequent input indicating that the emotional state of the user remains the first emotional state.

In one or more embodiments, electronic device 100 includes microphone 153 that is communicatively coupled to processor 112. Processor 112 is further configured to cause electronic device 100 to perform background monitoring of audio input 209 received at microphone 153. Processor 112 is further configured to cause electronic device 100 to determine from audio inputs 209 that user 102 is in the first emotional state by detecting a voice pattern contained in audio inputs 209 indicative of the first emotional state.

In one or more embodiments, electronic device 100 includes physiological sensor 211, such as incorporated into wearable computing device 192, that is communicatively coupled to processor 112. Processor 112 is further configured to cause electronic device 100 to perform background monitoring of physiological inputs 213 (e.g., heart or pulse rate) received by physiological sensor 211. Processor 112 is further configured to cause electronic device 100 to determine from a physiological pattern contained in physiological inputs 213 that user 102 is in the first emotional state.

In one or more particular embodiments, electronic device 100 includes a companion device such as wearable computing device 192 configured to be worn by user 102 incorporating physiological sensor 211, such as a heart rate monitor. One of electronic device 100 and the companion device includes motion sensor 158a. Processor 112 is further configured to cause electronic device 100 to perform background monitoring of movement inputs received by motion sensor 158a. Processor 112 is further configured to cause electronic device 100 to determine from a motion pattern contained in the motion inputs whether user 102 is in an exercising state, which is associated as an alternate cause of the physiological pattern (e.g., elevated heart rate). Processor 112 is further configured to cause electronic device 100 to determine from the physiological inputs that user 102 is in the first emotional state based on the physiological pattern contained in the physiological inputs being indicative of the first emotional state, further in response to determining from that user 102 is not in the exercising state.

In one or more particular embodiments, COM module 125 includes an artificial intelligence (AI) engine 115 trained to predict the first emotional state by detecting a pattern contained in one or more inputs, where the one or more inputs are indicative of the first emotional state. In one or more embodiments, the AI engine is trained at least in part based on crowd-sourced inputs. In one or more embodiments, the AI engine is trained at least in part based on inputs originating from or associated with the user. In an example, AI engine is or includes one or more of AI OS 117 and AI model 126. In one or more particular embodiments, AI engine 115 is further trained to predict the first state of user 102 by monitoring one or more contextual conditions having one of a positive correlation or a negative correlation with the first emotional state of user 102.

In one or more embodiments, initiation of the communication event is or includes at least one of: (a) receipt of an incoming communication from among a group comprising: (i) an incoming voice call; and (ii) an incoming video call; and (b) preparation of an outgoing communication from among a group comprising: (i) an outgoing voice call; (ii) an outgoing video call; and (v) an outgoing text message; and (vi) an outgoing social post. In one or more embodiments, soothing output 203 is or includes one or more output types from a group of: (i) an audio output; (ii) a visual image output; and (iii) a textual message output.

In the description of each of the following figures, reference is also made to specific components illustrated within the preceding figure(s). Similar or same components are presented with the same leading reference number.

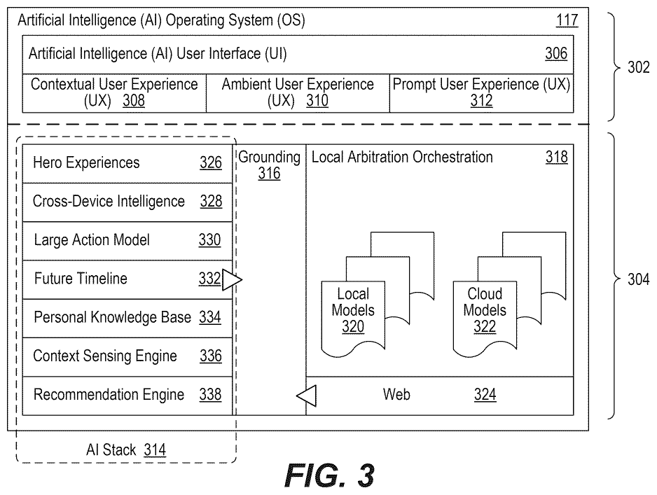

FIG. 3 illustrates a software platform diagram of an example artificial intelligence (AI) operating system (OS) 117. By learning about the user, AI OS 117 can anticipate future actions of the user and provide recommendations for the user, improving user experience. AI OS 117 supports functionality of COM module 125 (FIG. 1A) that adds functionality for managing communication connection operation responsive to a first emotional state of a user. AI OS 117 includes user plane 302 supported by control plane 304. User plane includes AI user interface (UI) 306 that supports contextual user experience (UX) component 308, ambient UX component 310, and prompt UX component 312. Control plane 304 includes AI agents 314 that communicate via grounding component 316 to local arbitration orchestration component 318 having local models 320 and cloud models 322. AI agents 314 communicates via grounding component 316 to web interface 324. AI agents 314 includes hero experiences agent 326, cross-device intelligence agent 328, large action model 330, future timeline 332, personal knowledge base 334, context sensing engine 336, and recommendation engine 338.

User experience (UX) design is defined as a multidisciplinary field that focuses on enhancing the overall experience that individuals have when interacting with a digital product, system, or service. UX design encompasses various aspects of user interaction, including usability, accessibility, aesthetics, and overall satisfaction. UX design aim to create meaningful and positive experiences for users by understanding their needs, behaviors, and preferences.

Grounding component 316 in AI is an essential process that ensures AI systems comprehend and interact with the real world accurately. Grounding is a bridge between abstract AI concepts and practical, tangible outcomes. Grounding allows AI systems to bridge semantic gaps in the real world, team with other agents in such environments, process inputs from the environment, and learn from interactions. A successful synthetic teammate requires several cognitive capacities, including situation assessment, task behavior, language comprehension and generation, and knowledge gap resolution processes. Grounding enables agents with different capabilities to communicate. [INVENTORS: the figure was included in the invention disclosure. Is there more to be said about it and what aspects are leveraged in the current invention?]

FIG. 4 illustrates data and processing flow diagram 401 for COM module 125 providing functionality for receiving and processing context aware, personal, collaborative, and ubiquitous data sources for determining whether user 102 is in a first emotional state. The functionality of COM module 125 may be based on one or more of visual indications 402, voice indications 404, contextual indications 406, and physiological indications 408. Visual indications 402 may be based on receiving visual input 410 by image capturing device 152 of face 412 of user 102. COM module 125 may detect visual indication based on facial expression, skin coloration, such as flushing, hand gestures, and frequent head movements. Voice indications 404 include audio input 209 received by microphone 153. COM module 125 analyzes audio input 209 for one or more characteristic, such as pitch, tone, speed, modulation, and objectionable content. COM module 125 may provide functionality of comparing the analyzed characteristic(s) of audio input 209 to a baseline audio input of spoken content by user 102 when COM module 125 has determined user 102 is in baseline emotional state 414 and not in first emotional state 416. Contextual indications 406 may be contextual inputs 418 that are collected and analyzed by COM module 125 or by AI OS 117 (FIG. 3). In an example, contextual inputs 418 may include COM module 125 identifying second user 171. In an example, caller identification (ID) may be provided for second user 171 as part of a received call request. In another example, electronic device 100 may maintain contacts in a personal knowledge base that identifies at least a name and communication address (e.g., telephone number) for second user 171. Based on the identification, COM module 125 may identify that second user 171 has previously antagonized user 102 resulting in user 102 being in first emotional state 416. Contextual input 418 may be a preceding communication from second user 171. COM module 125 may include functionality for determining that the preceding communication has antagonized or otherwise upset user 102. Physiological indications 408 may include physiological inputs 213 such as heart or pulse rate detected by a physiological sensor 211. COM module 125 may have functionality for comparing physiological inputs 213 to a baseline line for user 102 to detect baseline second emotional state 414 or first emotional state 416. In one or more embodiments, COM module 125 may receive motion inputs from motion sensor 158a that are indicative of user 102 exercising or not exercising. COM module 125 may determine that user 102 is in a baseline emotional state 414 when exercising, especially when there are no other visual indications 402, voice indications 404, or contextual indications 406 to determine otherwise.

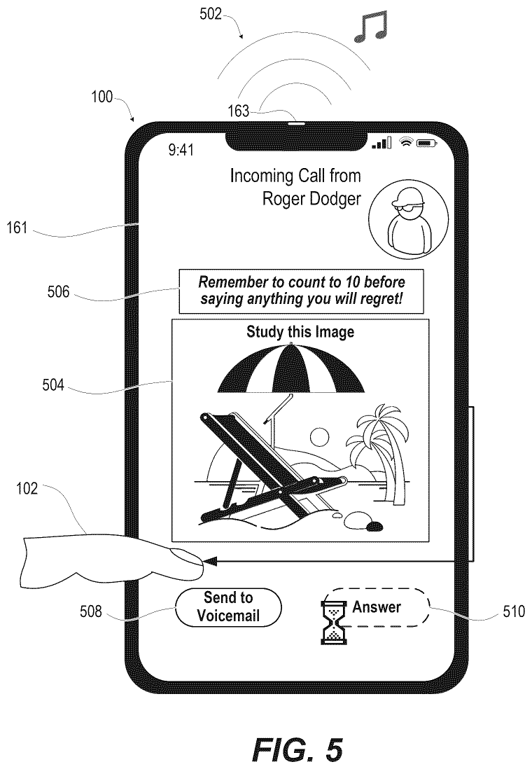

FIG. 5 illustrates display 161 of electronic device 100 presenting soothing output 203 (FIG. 2) in response to identifying a first emotional state of user during an incoming call request. The incoming call is an example of a time when a communication event with a second electronic device is being connected. In an example, audio output device 163 of electronic device 100 may present aural soothing output 502 such as a calming melody, nature sounds, or binaural beats. In another example, soothing audio output 502 may replace or augment sound played for receiving a voice or video call. In another example, electronic device 100 may present soothing visual image output 504 such as visual image and a change in background color(s) that have a calming effect. Crowd sourced or user specific learning by AI engine 115 of AI model 126 (FIG. 1A) enable selection of content predicted to calm user 102. In an additional example, soothing textual output 506 may be presented to remind user 102 of a soothing thought. The amount of text of soothing textual output 506 may require a period of time to read to facilitate soothing. While attempting to calm user 102, electronic device 100 may delay initiation of communication by user 102. In an example, send to voicemail control 508 is enabled whereas answer control 510 is disabled for a period of time or until detecting that the user has been calmed. Send to voicemail control 508 allows the user to refuse the communication connection, avoiding any regrettable outgoing communication. In some embodiments, electronic device 100 automatically disables answer control 510 to delay the communication connection.

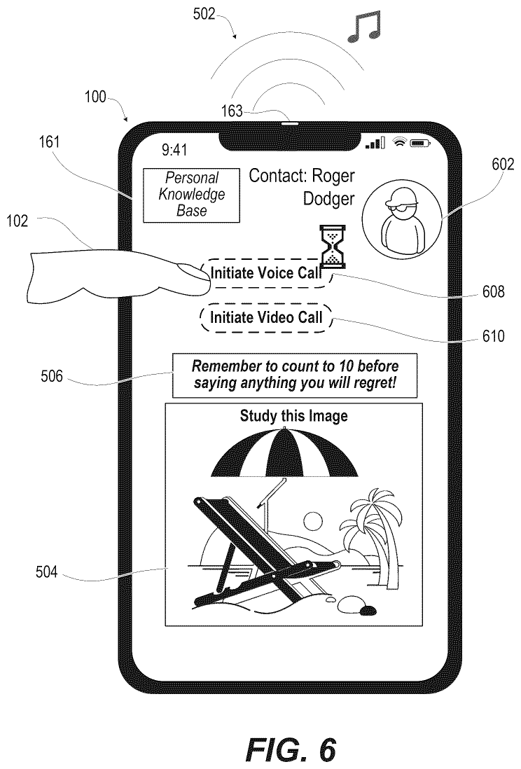

FIG. 6 illustrates display 161 of electronic device 100 presenting soothing output 203 (FIG. 2) in response to identifying a first emotional state of user while the user is viewing contact 602 in a personal knowledge base. The user performing audio or video call initiation is another example of a time when a communication event with a second electronic device is being connected. In order to attempt to calm user 102, electronic device 100 may delay initiation of communication by user 102. In an example, initiate voice call control 608 and initiate video call control 610 are automatically disabled for a period of time or until the user is detected as having been calmed.

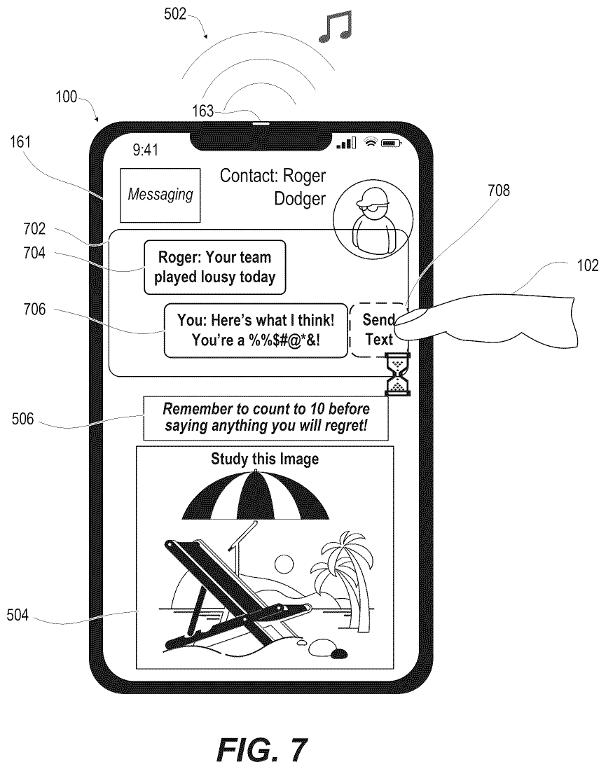

FIG. 7 illustrates display 161 of electronic device 100 presenting soothing output 203 (FIG. 2) in response to identifying a first emotional state of user during a chat conversation. For purposes of the disclosure, the user engaging in the chat conversation is considered as another example of a time when a communication event with a second electronic device is being connected. Chat conversation window 702 includes incoming text 704 that provokes user 102 to type outgoing text 706. While attempting to sooth user 102, in an example, send text control 708 is disabled for a period of time or until the user is detected as having been calmed.

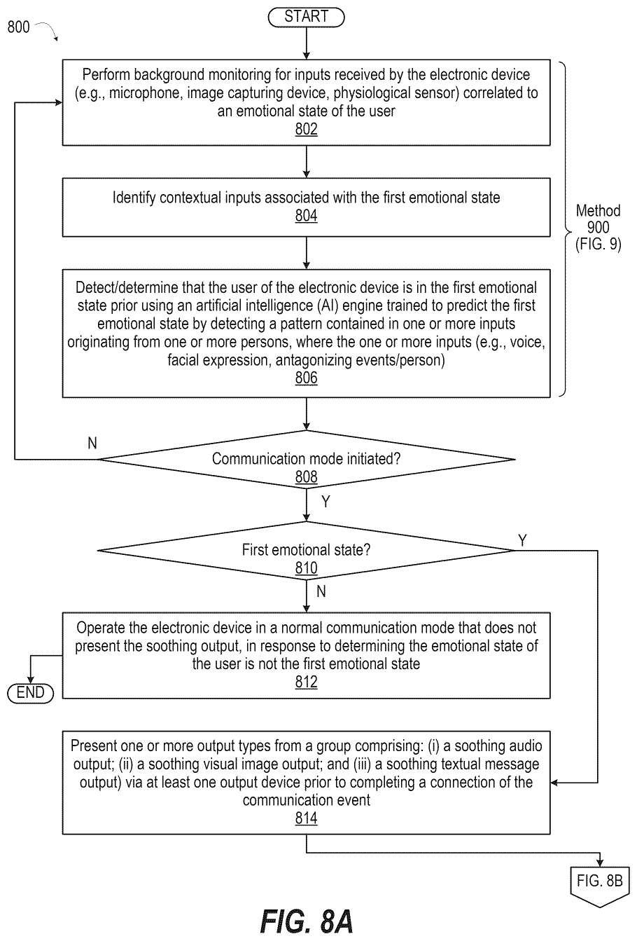

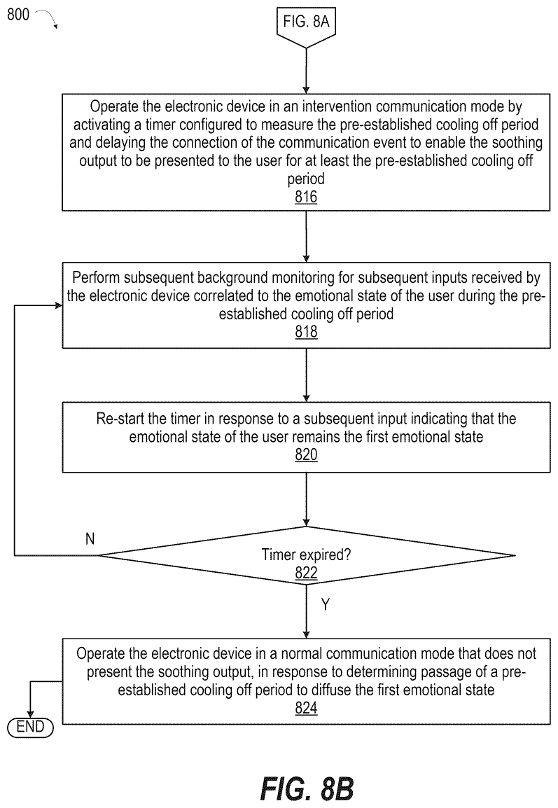

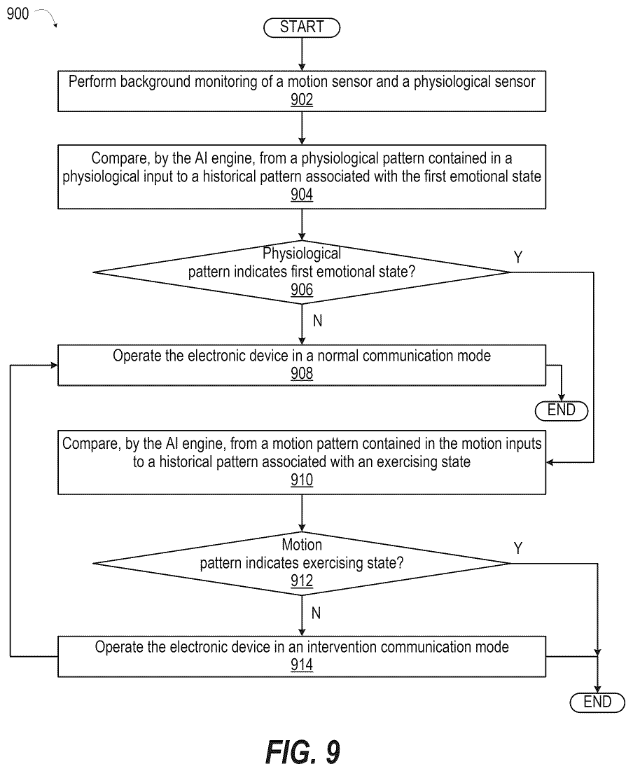

FIGS. 8A-8B (collectively “FIG. 8”) are a flow diagram presenting computer-implement method 800 for presenting soothing output(s) in response to a first emotional state of a user of the communication device user during a communication connection process. Method 800 also includes delaying the communication connection process. FIG. 9 is a flow diagram presenting a computer-implement method that augments method 800 of FIG. 8 for identifying the first emotional state based on a physiological input and a motion input. The descriptions of method 800 (FIG. 8) and method 900 (FIG. 9) is provided with general reference to the specific components illustrated within the preceding FIGS. 1-7. Specific components referenced in method 800 (FIG. 8) and method 900 (FIG. 9) may be identical or similar to components of the same name used in describing preceding FIGS. 1-7. In one or more embodiments, controller 110 (FIG. 1A) configures electronic device 100 (FIGS. 1A-1B) or a similar computing device to provide the described functionality of method 800 (FIG. 8) and method 900 (FIG. 9).

With reference to FIG. 8A, method 800 includes performing background monitoring for inputs received by the electronic device (e.g., microphone, image capturing device, physiological sensor) correlated to an emotional state of the user (block 802). Method 800 includes identifying contextual inputs associated with the first emotional state (block 804). Method 800 includes detecting/determining that the user of the electronic device is in the first emotional state by using an artificial intelligence (AI) engine trained to predict the first emotional state by detecting a pattern contained in one or more inputs, where the one or more inputs (e.g., voice, facial expression, antagonizing event/person) are indicative of the first emotional state (block 806). In one or more embodiments, the AI engine is trained at least in part based on crowd-sourced inputs. In one or more embodiments, the AI engine is trained at least in part based on inputs originating from or associated with the user. In one or more embodiments, detecting the first emotional state is based on physiological input(s). In one or more embodiments, detecting the first emotional state is based on both physiological input(s) and motion input as described below with regard to FIG. 9. With continued reference to FIG. 8A, the AI engine is further trained to predict the first state of the user by monitoring one or more contextual conditions having one of a positive correlation or a negative correlation with the first emotional state of the user. Method 800 includes determining whether a communication mode is initiated (decision block 808). In an example, the communication mode is initiated by receiving an incoming request for a communication session (e.g., two-way audio or video call, or text chat). In another example, the user may select a control to make an outgoing request for a communication session (e.g., one-way or two-way audio or video call or text chat).

In response to determining that a communication mode is not initiated, method 800 returns to block 802 and continues performing background monitoring. In response to determining that a communication mode is initiated, method 800 includes determining whether the user is in a first emotional state (decision block 810). In response to determining that the user is not in first emotional state (e.g., user is in a baseline second emotional state), method 800 includes operating the electronic device in a normal communication mode that does not present the soothing output or delays in establishing the communication (block 812). Then method 800 ends. In response to determining that the user is in first emotional state, method 800 includes presenting one or more output types from a group comprising: (i) a soothing audio output; (ii) a soothing visual image output; and (iii) a soothing textual message output) via at least one output device prior to completing a connection of the communication event (block 814). Then method 800 proceeds to block 816 of FIG. 8B.

With reference to FIG. 8B, method 800 includes operating the electronic device in an intervention communication mode by activating a timer configured to measure the pre-established cooling off period and delaying the connection of the communication event to enable the soothing output to be presented to the user for at least the pre-established cooling off period (block 816). Method 800 includes performing subsequent background monitoring for subsequent inputs received by the electronic device correlated to the emotional state of the user during the pre-established cooling off period (block 818). Method 800 includes re-starting the timer in response to a subsequent input indicating that the emotional state of the user remains the first emotional state (block 820). Method 800 includes determining whether the timer has expired (decision block 822). In response to determining that the timer has expired, indicating passage of the pre-established cooling off period to diffuse the first emotional state, method 800 includes connecting the communication and returning the electronic device to operate in a normal communication mode that does not include presenting a soothing output prior to connecting a communication (block 824). Then method 800 ends. In response to determining that the timer has not expired, method 800 returns to block 818 to perform background monitoring for subsequent inputs.

According to aspects of the present disclosure, in response to detecting that a user of an electronic device is in a first emotional state prior to connecting a communication event between an electronic device and at least a second electronic device, method 800 may include presenting a soothing output via at least one output device prior to completing a connection of the communication event. Method 800 includes delaying the connection of the communication event to enable the soothing output to be presented to the user for at least a pre-established cooling off period.

In one or more embodiments, method 800 may further include performing background monitoring of a motion sensor and a physiological sensor for inputs received by the electronic device correlated to an emotional state of the user. Method 800 may further include determining from the inputs whether the emotional state of the user is the first emotional state. Method 800 may further include setting a communication mode of the electronic device to an intervention communication mode that requires soothing the user is to be completed prior to completion of a subsequent connection while the emotional state of the user is determined to be the first emotional state. Method 800 may further include operating the electronic device in a normal communication mode that does not present the soothing output, in response to one of (i) determining the emotional state of the user is not the first emotional state or (ii) passage of a pre-established cooling off period to diffuse the first emotional state.

In one or more particular embodiments, in response to determining from the inputs that the emotional state of the user is the first emotional state, method 800 may further include activating a timer configured to measure the pre-established cooling off period. Method 800 may further include performing subsequent background monitoring for subsequent inputs received by the electronic device correlated to the emotional state of the user during the pre-established cooling off period. Method 800 may further include re-starting the timer in response to a subsequent input indicating that the emotional state of the user remains the first emotional state.

In one or more embodiments, method 800 may further include performing background monitoring of audio input received at a microphone. Method 800 may further include determining from the audio inputs that the user is in the first emotional state by detecting a voice pattern contained in the audio inputs indicative of the first emotional state.

In one or more embodiments, method 800 may further include performing background monitoring of physiological inputs received by a physiological sensor. Method 800 may further include determining from a physiological pattern contained in the physiological inputs that the user is in the first emotional state.

In one or more particular embodiments, method 800 may further include communicatively connecting, via a communications subsystem, to a companion device configured to be worn by the user and incorporating the physiological sensor including a heart rate monitor. One of the electronic device and the companion device includes a motion sensor. Method 800 may further include performing background monitoring of the motion sensor of movement inputs received by the motion sensor. Method 800 may further include determining from a motion pattern contained in the motion inputs whether the user is in an exercising state that can be an alternate cause of the physiological pattern. Method 800 may further include determining from the physiological inputs that the user is in the first emotional state by the physiological pattern contained in the physiological inputs indicative of the first emotional state further in response to determining from that the user is not in the exercising state.

In one or more embodiments, method 800 may further include detecting that the user of the electronic device is in the first emotional state prior to connecting the communication event by using an artificial intelligence (AI) engine trained to predict the first emotional state by detecting a pattern contained in one or more inputs. The one or more inputs are indicative of the first emotional state. The AI engine is further trained to predict the first state of the user by monitoring one or more contextual conditions having one of a positive correlation or a negative correlation with the first emotional state of the user.

In one or more embodiments, initiation of the communication event includes one of: (a) receiving an incoming communication from among a group including: (i) an incoming voice call; and (ii) an incoming video call; and (b) preparing an outgoing communication from among a group comprising: (i) an outgoing voice call; (ii) an outgoing video call; and (v) an outgoing text message; and (vi) an outgoing social post. The soothing output includes one or more output types from a group that includes: (i) a soothing audio output; (ii) a soothing visual image output; and (iii) a soothing textual message output.

With reference to FIG. 9, method 900 may further include performing background monitoring of a motion sensor and a physiological sensor for inputs received by the electronic device correlated to an emotional state of the user (block 902). In an example, the method 900 may further include communicatively connecting, via a communications subsystem, to a companion device configured to be worn by the user and incorporating a physiological sensor including a heart rate monitor, where one of the electronic device and the companion device includes a motion sensor. With continuing reference to FIG. 9, method 900 may further include comparing, by the AI engine, a physiological pattern contained in a physiological input to a historical pattern. Method 900 includes determining whether a physiological pattern indicates the first emotional state (decision block 906). In response to determining that the physiological pattern does not indicate the first emotional state, method 900 includes operating the electronic device in a normal communication mode (block 908). Then method 900 ends. In response to determining that the physiological pattern indicates the first emotional state, method 900 includes comparing, by the AI engine, a motion pattern contained in the motion inputs to a historical pattern associated with an exercising state (block 910). Method 900 includes determining whether a motion pattern indicates an exercising state (decision block 912). In response to determining that the motion pattern indicates an exercising state, method 900 returns to block 908. In response to determining that the motion pattern does not indicate an exercising state (i.e., the physiological pattern is not a result of exercise and is thus likely a result of an emotional response), method 900 includes operating the electronic device in an intervention communication mode (block 914). Then method 900 ends.

According to aspects of the present disclosure, the electronic device 100 (FIG. 1A), method 800 (FIG. 8), method 900 (FIG. 9), and computer program product, such as RSD 145 (FIG. 1A), provide techniques for detecting and mitigating the first emotional state of user 102 (FIG. 1A) during a communication connection (e.g., receiving a call, originating a call, sending a communication message) by soothing user 102 (FIG. 1A) by presenting visual, audio and text soothing content. The first emotion state affects user 102 (FIG. 1A) to be less restrained and careful in what is communicated to second user(s) 171 (FIG. 1A). By soothing user 102 (FIG. 1A), electronic device 100 prevents negative or detrimental repercussions of an ill-advised and objectionable communication by user 102 (FIG. 1A) who is in the first emotional state. In particular, the electronic device performs various techniques for delaying call initiation and presenting soothing output during call initiation. The call initiation may be for an incoming two-way voice, video or textual chat call. The call initiation may be for an outgoing voice, video or text communication. Electronic device 100 (FIG. 1A) may determine or predict that the user will be in the first emotional state based on monitoring one or more of visual, aural, contextual, and physiological inputs. The soothing output may be one or more of aural and visual outputs. The electronic device 100 (FIG. 1A) learns historical patterns for the user to better determine when the user is in a first emotional state and what soothing outputs will successfully calm the user. The comprehensive management of call operation may prevent the user communicating a spoken, gestured, or typed comment that would have negative repercussions, such as damaging a relationship or otherwise invoking negative consequences for the user.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one input device;
at least one output device;
a memory comprising a communication operation management module;
a communications subsystem that links the electronic device to a communication network; and
a processor communicatively coupled to the at least one input device, the at least one output device, the memory, and the communications subsystem, and which is configured to cause the electronic device to:
in response to detecting that a user of the electronic device is in a first emotional state at a time a communication event with a second electronic device is being connected,
present a soothing output via the at least one output device prior to completing a connection of the communication event.

2. The electronic device of claim 1, wherein the processor is further configured to cause the electronic device to delay the connection of the communication event to enable the soothing output to be presented to the user for at least a pre-established cooling off period.

3. The electronic device of claim 2, wherein the processor is further configured to cause the electronic device to:
perform background monitoring for inputs received by the electronic device correlated to an emotional state of the user;
determine from the inputs whether the emotional state of the user is the first emotional state;
set a communication mode of the electronic device to an intervention communication mode indicating that soothing the user is to be completed prior to completion of a subsequent connection while the emotional state of the user is determined to be the first emotional state; and
operate the electronic device in a normal communication mode that does not present the soothing output, in response to one of (i) determining the emotional state of the user is not the first emotional state or (ii) passage of the pre-established cooling off period to diffuse the first emotional state.

4. The electronic device of claim 3, wherein the processor is further configured to cause the electronic device to:
in response to determining from the inputs that the emotional state of the user is the first emotional state:
activate a timer configured to measure the pre-established cooling off period;
perform subsequent background monitoring for subsequent inputs received by the electronic device correlated to the emotional state of the user during the pre-established cooling off period; and
re-start the timer in response to a subsequent input indicating that the emotional state of the user remains the first emotional state.

5. The electronic device of claim 1, further comprising a microphone communicatively coupled to the processor, and wherein the processor is further configured to cause the electronic device to:
perform background monitoring of audio input received at the microphone; and
determine from the audio inputs that the user is in the first emotional state by detecting a voice pattern contained in the audio inputs indicative of the first emotional state.

6. The electronic device of claim 1, further comprising a physiological sensor communicatively coupled to the processor, and wherein the processor is further configured to cause the electronic device to:
perform background monitoring of physiological inputs received by the physiological sensor; and
determine from a physiological pattern contained in the physiological inputs that the user is in the first emotional state.

7. The electronic device of claim 6, further comprising a companion device configured to be worn by the user and incorporating the physiological sensor comprising a heart rate monitor, wherein one of the electronic device and the companion device comprises a motion sensor, and wherein the processor is configured to cause the electronic device to:
perform background monitoring of the motion sensor of movement inputs received by the motion sensor;
determine from a motion pattern contained in the motion inputs whether the user is in an exercising state associated with an alternate cause of the physiological pattern; and
determine from the physiological inputs that the user is in the first emotional state by the physiological pattern contained in the physiological inputs indicative of the first emotional state further in response to determining from that the user is not in the exercising state.

8. The electronic device of claim 1, wherein the communication operation management module comprises an artificial intelligence (AI) engine trained to predict the first emotional state by detecting a pattern contained in one or more inputs, where the one or more inputs are indicative of the first emotional state, and where the AI engine is further trained to predict the first state of the user by monitoring one or more contextual conditions having one of a positive correlation or a negative correlation with the first emotional state of the user.

9. The electronic device of claim 1, wherein:
initiation of the communication event comprises at least one of:
receipt of an incoming communication from among a group comprising: (i) an incoming voice call; and (ii) an incoming video call; and
prepare an outgoing communication from among a group comprising: (i) an outgoing voice call; (ii) an outgoing video call; and (v) an outgoing text message; and (vi) an outgoing social post.

10. The electronic device of claim 1, wherein the soothing output comprises one or more output types from a group comprising: (i) a soothing audio output; (ii) a soothing visual image output; and (iii) a soothing textual message output.

11. A method comprising:
in response to detecting that a user of an electronic device is in a first emotional state prior to connecting a communication event between an electronic device and at least a second electronic device:
presenting a soothing output via at least one output device prior to completing a connection of the communication event.

12. The method of claim 11, further comprising delaying the connection of the communication event to enable the soothing output to be presented to the user for at least a pre-established cooling off period.

13. The method of claim 12, further comprising:
performing background monitoring for inputs received by the electronic device correlated to an emotional state of the user;
determining from the inputs whether the emotional state of the user is the first emotional state;
setting a communication mode of the electronic device to an intervention communication mode indicating that soothing the user is to be completed prior to completion of a subsequent connection while the emotional state of the user is determined to be the first emotional state; and
operating the electronic device in a normal communication mode that does not present the soothing output, in response to one of (i) determining the emotional state of the user is not the first emotional state or (ii) passage of a pre-established cooling off period to diffuse the first emotional state.

14. The method of claim 13, further comprising:
in response to determining from the inputs that the emotional state of the user is the first emotional state:
activating a timer configured to measure the pre-established cooling off period;
performing subsequent background monitoring for subsequent inputs received by the electronic device correlated to the emotional state of the user during the pre-established cooling off period; and
re-starting the timer in response to a subsequent input indicating that the emotional state of the user remains the first emotional state.

15. The method of claim 12, further comprising:
performing background monitoring of audio input received at a microphone; and
determining from the audio inputs that the user is in the first emotional state by detecting a voice pattern contained in the audio inputs indicative of the first emotional state.

16. The method of claim 12, further comprising:
performing background monitoring of physiological inputs received by a physiological sensor; and
determining from a physiological pattern contained in the physiological inputs that the user is in the first emotional state.

17. The method of claim 15, further comprising:
communicatively connecting, via a communications subsystem, to a companion device configured to be worn by the user and incorporating a physiological sensor comprising a heart rate monitor, wherein one of the electronic device and the companion device comprises a motion sensor;
performing background monitoring of the motion sensor of movement inputs received by the motion sensor;
determining from a motion pattern contained in the motion inputs whether the user is in an exercising state associated with an alternate cause of the physiological pattern; and
determining from the physiological inputs that the user is in the first emotional state by the physiological pattern contained in the physiological inputs indicative of the first emotional state further in response to determining from that the user is not in the exercising state.

18. The method of claim 11, wherein:
initiation of the communication event comprises one of:
receiving an incoming communication from among a group comprising: (i) an incoming voice call; and (ii) an incoming video call; and
preparing an outgoing communication mode from among a group comprising: (i) an outgoing voice call; (ii) an outgoing video call; and (v) an outgoing text message; and (vi) an outgoing social post; and
the soothing output comprises one or more output types from a group comprising: (i) a soothing audio output; (ii) a soothing visual image output; and (iii) a soothing textual message output.

19. A computer program product comprising:
a computer readable storage device; and
program code on the computer readable storage device that when executed by a processor associated with an electronic device, the program code is configured to cause the electronic device to provide functionality of:
in response to detecting that a user of the electronic device is in a first emotional state prior to connecting a communication event between the electronic device and at least a second electronic device:
presenting a soothing output via at least one output device prior to completing a connection of the communication event.

20. The computer program product of claim 19, wherein the program code is configured to cause the electronic device to provide functionality of:
in response to determining from inputs that the emotional state of the user is the first emotional state:
delaying the connection of the communication event to enable the soothing output to be presented to the user for at least a pre-established cooling off period.
